(19) United States
(12) Patent Application Publication
(10) Pub. No.: US 2009/0316271 A1
(43) Pub. Date: Dec. 24, 2009

(54) Antireflection Film

(75) Inventor: Naoyuki Shibayama, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/485,835

(22) Filed: Jun. 16, 2009

(30) Foreign Application Priority Data
Jun. 23, 2008 (JP) 2008-163087

(51) Int. Cl. G02B 1/11

(52) U.S. Cl. 359/601

(57) ABSTRACT

The present invention provides an antireflection film which has sufficient antireflection properties and antistatic properties, a high level of light transmittance and no interference fringe at a low cost. It is a feature of the antireflection film of the present invention that a hard coat layer and an antireflection layer is formed on a transparent substrate, a conductive polymer is included in the hard coat layer, a light reflectance on the low refractive index layer is in the range of 0.5-1.5%, a surface resistance of the low refractive index layer is less than 1×10¹⁰ [Ω/cm²]. In addition, it is also a feature of the antireflection film of the present invention that conductive metal oxide particles are included in the hard coat layer and a surface resistance of the low refractive index layer after the antireflection film is kept in a light resistance testing instrument employing an ultraviolet carbon arc lamp according to JIS B 7751 for 500 hours is less than (or equal to) 1×10¹⁰ [Ω/cm²].

### CROSS REFERENCE TO RELATED APPLICATION

This application is based on and claims the benefit of priority from the Japanese Patent Application number 2008-163087, filed on Jun. 23, 2008, the entire contents of which are incorporated herein by reference.

### BACKGROUND OF THE INVENTION

1. Field of the Invention

The present invention relates to an antireflection film which has antireflection properties and antistatic properties. In particular, the present invention relates to an antireflection film which is applied on a surface of a display such as an LCD, a PDP display, a CRT display, a projection display and an electroluminescence display.

2. Description of the Related Art

In general, displays are used under external light whether they are used indoors or outdoors. The external light incident to a display surface is reflected on the surface so that a displayed image is interfered with by the reflected image and the quality of display decreases. Hence, it is necessary to provide a display surface with antireflection properties and a high level of antireflection functionality combined with extra useful functions is being demanded.

Antireflection properties are generally obtained by forming a multilayer including transparent layers of metal oxides etc. on a transparent substrate as an antireflection layer. Dry coating methods such as a CVD (chemical vapor deposition) method or a PVD (physical vapor deposition) method are proposed as a forming method of the multilayer. In addition, wet coating methods, which make it possible to manufacture continuously, treat large size displays, and reduce costs, are also proposed as forming methods of the antireflection layer.

In addition, in order to provide the antireflection layer with surface hardness, a hard coat layer which generally includes a polymer of a polyfunctional acrylic compound is formed before the antireflection layer is arranged because the antireflection layer has a relatively soft surface. In spite of providing a high level of surface hardness, transparency, lustrous properties and abrasion resistance, which is specific to acrylic resin, the hard coat layer also provides such an undesirable charging due to a high level of insulating properties that problems such as dust causing dirt on the surface of the hard coat layer and/or productive failures related to electrical charging causing defects on a display device occur.

Thus, in an antireflection film having an antireflection layer and a hard coat layer, a method which provides an antistatic function to the hard coat layer and a method in which an antistatic layer is arranged between the transparent substrate and the hard coat layer or between the antireflection layer and the hard coat layer are proposed.

### <Patent Document 1>JP-A-H11-092750

### SUMMARY OF THE INVENTION

It is desired that an inexpensive antireflection film which includes a hard coat layer having an antistatic function is developed since arranging an antistatic layer between the substrate and the hard coat layer or between the antireflection layer and the hard coat layer requires additional costs.

In general, a method of dispersing conductive particles in the hard coat layer is adopted for the purpose of providing the hard coat layer with antistatic properties. This method, however, has a problem of decreasing the light transmission because in the case where conductive particles are dispersed in the hard coat layer, it is necessary to disperse a significant amount of conductive particles in the hard coat layer. In addition, there is also a problem that interference fringes are observed due to an increase in the refractive index of the hard coat layer.

It is an object of the present invention to provide an antireflection film which has a hard coat layer and a low refractive index layer in this order on a transparent substrate and which has sufficient antireflection properties, antistatic properties, a high level of light transmission and no interference fringes at a low cost.

In order to solve the problems mentioned above, a first aspect of the present invention is an antireflection film which includes a transparent substrate, a hard coat layer, and a low refractive index layer, the low refractive index layer having an average luminous reflectance in the range of 0.5-1.5% and a surface resistance less than (or equal to) 1×10¹⁰ [Ω/cm²].

In addition, a second aspect of the present invention is the antireflection film according to the first aspect of the present invention, wherein the hard coat layer includes conductive metal oxide particles, and a surface resistance of the low refractive index layer after the antireflection film is kept for 500 hours in a light resistance testing instrument which employs an ultraviolet carbon arc lamp is less than (or equal to) 1×10¹⁰ [Ω/cm²].

In addition, a third aspect of the present invention is the antireflection film according to the first aspect of the present invention, wherein a light transmittance or a total luminous transmittance of the antireflection film is in the range of 92-98%.

In addition, a fourth aspect of the present invention is the antireflection film according to the first aspect of the present invention, wherein a haze of the antireflection film is in the range of 0.1-0.5%.

In addition, a fifth aspect of the present invention is the antireflection film according to the first aspect of the present invention, wherein low refractive index particles are included in the low refractive index layer.

In addition, a sixth aspect of the present invention is a polarizing plate having the antireflection film according to the first aspect of the present invention.

In addition, a seventh aspect of the present invention is a display device having the antireflection film according to the first aspect of the present invention.

An antireflection film which has sufficient antistatic properties, a high level of light transmittance, and no interference fringe can be obtained at a low cost by fabricating such an antireflection film described above.

### BRIEF DESCRIPTION OF THE DRAWINGS

FIG. 1 is an exemplary diagram showing a cross sectional view of an antireflection film of the present invention.

FIG. 2 is an exemplary diagram showing a cross sectional view of a polarizing plate employing an antireflection film of the present invention.

FIG. 3 is an exemplary diagram showing a cross sectional view of a transmission type LCD which includes an antireflection film of the present invention.

FIG. 4 is a graph of the spectral reflectivity of the antireflection film obtained in Example 1.

FIG. 5 is a graph of the spectral reflectivity of the antireflection film obtained in Example 2.

FIG. 6 is a graph of the spectral reflectivity of the antireflection film obtained in Example 3.

FIG. 7 is a graph of the spectral reflectivity of the antireflection film obtained in Example 4.

FIG. 8 is a graph of the spectral reflectivity of the antireflection film obtained in Comparative example 1.

FIG. 9 is a graph of the spectral reflectivity of the antireflection film obtained in Comparative example 2.

FIG. 10 is a graph of the spectral reflectivity of the antireflection film obtained in Comparative example 3.

### DESCRIPTION OF REFERENCE NUMERALS AND SIGNS

1: Antireflection film
11: Transparent substrate
12: Hard coat layer
13: Low refractive index layer (antireflection layer)
2: Polarizing plate
21: Transparent substrate
22: Polarizing layer
23: Transparent substrate
3: Liquid crystal cell
4: Polarizing plate
41: Transparent substrate
42: Polarizing layer
43: Transparent substrate
5: Backlight unit

### DETAILED DESCRIPTION OF THE INVENTION

The present invention is described below.

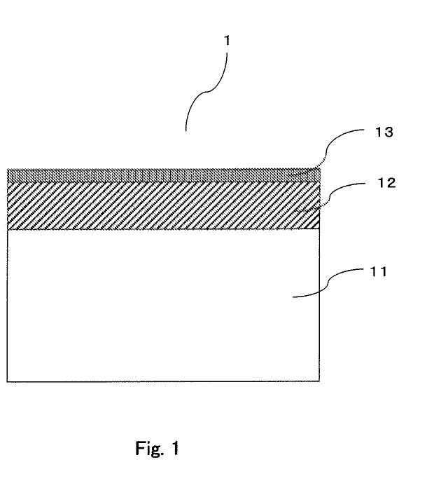

FIG. 1 illustrates an exemplary diagram of a cross sectional view of an antireflection film of the present invention. It is a feature of an antireflection film 1 of the present invention that a hard coat layer 12 and a low refractive index layer 13 are formed in this order on a transparent substrate 11.

In the antireflection film 1 of the present invention, the hard coat layer has antistatic properties. As a result, no additional antistatic layer is formed so that the antireflection film of the present invention can be manufactured at a low cost.

In addition, it is also a feature of the antireflection film of the present invention that the hard coat layer includes a conductive polymer. Polyacetylene, polyaniline, polythiophene, polypyrrole, polyphenylene sulfide, poly(1,6-heptadiyne), polybiphenylene, polyparaphenylene, polyparaphenylene sulfide, polyphenylacetylene, poly(2,5-thienylene) or a derivative compound of these, or a mixture of any combination selected among these can be used as the conductive polymer.

It is possible to provide antistatic properties to the hard coat layer by forming the hard coat layer with such a conductive polymer. As a result, it is possible to prevent the hard coat layer from obtaining a smaller light transmission than that in the case where the antistatic hard coat layer is formed using merely conductive particles such as metal particles or metal oxide particles. Furthermore, it is also possible to prevent generating interference unevenness (interference fringes).

The larger the difference in refractive index between the transparent substrate and the hard coat layer is, the more severe the interference unevenness on the antireflection film becomes. By using a conductive polymer in the antireflection film of the present invention it is possible to prevent the hard coat layer from obtaining a higher refractive index than that in the case where the antistatic hard coat layer is formed using merely conductive particles such as metal particles or metal oxide particles so that an antireflection film with no interference unevenness is fabricated. In addition, a decrease in abrasion resistance on the antireflection surface and a decrease in adhesion between the hard coat layer and the transparent substrate can be observed when the hard coat layer is formed using merely conductive particles such as metal particles or metal oxide particles.

It is a feature of the antireflection film of the present invention that an average luminous reflectance is in the range of 0.5-1.5%. If the average luminous reflectance is more than 1.5%, the antireflection film does not obtain sufficient antireflection properties. In addition, a small average luminous reflectance is also preferable from a viewpoint that the smaller average luminous reflectance is, the larger the antireflection properties become. The average luminous reflectance, however, is preferred to be more than (or equal to) 0.5% to select an appropriate low refractive index material and/or hard coat layer material. A spectral reflectance curve of the antireflection film of the present invention was measured after the opposite surface of the antireflection film from the low refractive index layer was deglossed with a matte-black paint, adjusting an angle of incident light to 5 degrees to the upright of the antireflection film surface, using a C light source as the light source, and making the condition of the field of view 2 degrees. The average luminous reflectance is an average reflectance which has been compensated with a relative luminous efficiency. At this time, the photopic standard relative luminous efficiency is used as the relative luminous efficiency.

It is a feature of the antireflection film of the present invention that the low refractive index layer has a surface resistance less than (or equal to) 1×10¹⁰ Ω/cm². In the case where an antistatic hard coat layer is formed merely using conductive particles such as metal particles or metal oxide particles, it is necessary to add a significant amount of conductive particles to provide the hard coat layer with a high level (less than (or equal to) 1×10¹⁰ Ω/cm²) of antistatic properties, which causes the production of interference unevenness. In the case where an antistatic hard coat layer is formed using a conductive organic material, however, it is possible to prevent a decrease in light transmission so that it is also possible to prevent interference unevenness. Therefore, the present invention provides an antireflection film which shows only a small decrease in light transmission if any and which has no interference unevenness, a high level of surface abrasion resistance and good adhesion between the transparent substrate and the hard coat layer as well as a high level of antistatic properties.

In addition, it is preferred that the antireflection film of the present invention includes not only the conductive polymer which is made of polyacetylene, polyaniline, polythiophene, polypyrrole, polyphenylene sulfide, poly(1,6-heptadiyne), polybiphenylene, polyparaphenylene, polyparaphenylene sulfide, polyphenylacetylene, poly(2,5-thienylene) or a derivative compound of these, or a mixture of any combination selected among these but also conductive particles such as conductive metal oxide etc.

In the case where an antistatic hard coat layer is formed merely using a conductive organic material, the antistatic properties may decrease in a light resistance test. In contrast, in the case where an antistatic hard coat layer is formed using both a conductive organic material and conductive particles such as metal oxide particles, the surface resistance of the resultant antireflection film does not increase even after a light resistance test. In other words, an antireflection film which has a surface resistance of the low refractive index layer less than 1×10¹⁰ Ω/cm² even after the antireflection film is kept in a light resistance tester employing a UV carbon-arc lamp can be obtained. A light resistance tester which is stipulated in JIS (Japanese Industrial Standard) B 7751 (1990) can be used as the light resistance tester employing a UV carbon-arc lamp.

The conductive polymer (or the conductive organic material) absorbs light to generate electrons, which damage the conductive polymer itself. If metal oxide particles are added to the hard coat layer, the metal oxide particles serve to remove the generated electrons from the hard coat layer so that it is possible to prevent the electrons from destroying the conductive polymer. As a result, an antireflection film which is free from an increase in surface resistance can be obtained.

It is preferable in the present invention that the antireflection film has a light transmission in the range of 92-98%. If the antireflection film has a light transmission of less than 92%, the antireflection film has an insufficient transmittance, which may be unsuitable for an application on a surface of a display device. In general, the higher the light transmission of the antireflection film is the better. It is, however, difficult to fabricate an antireflection film which has a light transmission more than 97.0% from the viewpoint of selecting a suitable material. The light transmission of the antireflection film of the present invention was measured conforming to JIS (Japanese Industrial Standard) K 7105 (1981).

It is preferable in the present invention that the antireflection film has a haze in the range of 0.1-0.5%. If the antireflection film has a haze less than (or equal to) 0.5%, it is possible to make a high contrast display applying the antireflection film on a display surface. In order to obtain a high contrast display, the lower the haze the antireflection film has the better. It is, however, difficult to fabricate an antireflection film which has a haze less than 0.1% from the viewpoint of designing a suitable material. The haze of the antireflection film of the present invention can be obtained by JIS (Japanese Industrial Standard) K 7105 (1981).

In addition, it is preferable in the antireflection film of the present invention that the low refractive index layer includes low refractive index particles in the binder matrix. A single low refractive index layer or a multilayer with repeating low refractive index layers and high refractive index layers can be formed as the antireflection layer arranged on the hard coat layer. In addition, a wet coating method, in which a coating liquid for forming an antireflection layer is coated on the surface of the hard coat layer to form the antireflection layer and a vacuum deposition method, in which the antireflection layer is formed on a surface of the hard coat layer under a vacuum condition by a method such as a sputtering method or a CVD method can be used as a forming method of the layer.

It is necessary to precisely control each layer's thickness in forming the antireflection layer of a multilayer with repeating low and high refractive index layers. Thus, a vacuum deposition method is required. The antireflection layer of the present invention can be fabricated at a low cost by forming a single low refractive index layer by a wet forming method using a low refractive index coating liquid which includes low refractive index particles and a binder matrix.

At this time, the single low refractive index layer is formed in a way that its optical thickness (nd) which is obtained by multiplying its thickness (d) by its refractive index (n) becomes equal to one fourth of the wavelength of the visible light.

The antireflection film of the present invention can be preferably applied on a surface of a display device such as an LCD, a PDP display, a CRT display, a projection display and an EL display etc. In addition, the present invention can also be used inside of a display device. An example of a case where the antireflection film of the present invention is used as a component of an LCD is described below.

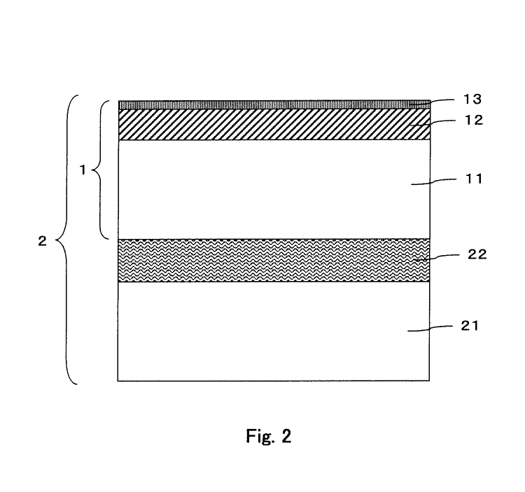

FIG. 2 shows an exemplary diagram of a cross section of a polarizing plate having the antireflection film of the present invention. The polarizing plate of the present invention has a polarizing layer 22 and a transparent substrate 21 on the opposite surface of a transparent substrate 11 from the hard coat layer 12.

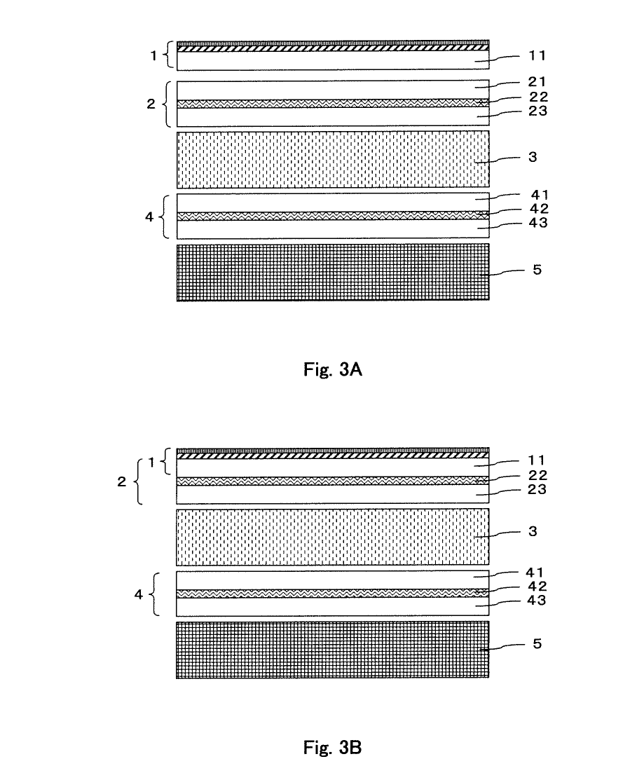

FIG. 3 shows an exemplary diagram of a cross section of the transmission type LCD having the antireflection film of the present invention. The transmission type LCD shown in FIG. 3A has a backlight unit 5, a polarizing plate 4, a liquid crystal cell 3, a polarizing plate 2 and an antireflection film 1 in the order of this description. At this time, the side of the antireflection film 1 corresponds to the observer's side, namely, the surface of the display device.

The backlight unit 5 has a light source and a light diffusion plate. The liquid crystal cell 3 has an electrode on a transparent substrate, the other electrode and a color filter on the other transparent substrate, and liquid crystals between these two transparent substrates. The liquid crystal cell 3 is arranged between the polarizing plates 2 and 4, in each of which a polarizing layer 22 or 42 is arranged between a pair of transparent substrates 21, 23 or 41, 43.

The transmission type LCD in FIG. 3A has a transparent substrate of the polarizing plate 2 arranged separately from the transparent substrate 11 of the antireflection film 1. In contrast, the transmission type LCD in FIG. 3B has a transparent substrate 11 shared by both the antireflection film 1 and the polarizing plate 2, and the polarizing layer 22 is arranged on the opposite side of transparent substrate 11 of the antireflection film 1 from the antireflection layer.

In addition, the transmission type LCD of the present invention may have other functional components. For example, a light diffusion film, a prism sheet and/or a luminance improving film, which make it possible to use light from the backlight unit efficiently, and a retardation film, which compensates for a phase difference produced by the liquid crystal cell and/or the polarizing plate, are included in the functional components. Any publicly known components can be used as the functional components.

A film or a sheet material of various organic polymers can be used as the transparent substrate of the present invention. For example, a material which is ordinarily used as an optical component of a display device, and a material made from a polyolefin such as polyethylene and polypropylene etc., a polyester such as polyethylene terephthalate and polyethylene naphthalate etc., a cellulose such as triacetyl cellulose, diacetyl cellulose and cellophane etc., a polyamide such as 6-nylon and 6,6-nylon etc., acrylate such as polymethyl methacrylate, polystyrene, polyvinyl chloride, polyimide, polyvinyl alcohol, polycarbonate, and/or ethylene vinyl alcohol etc. can be used considering their optical properties such as transparency and refractive index etc. along with other characteristics such as impact resistivity, heat resistance and endurance etc. In particular, polyethylene terephthalate, triacetyl cellulose, polycarbonate and polymethyl methacrylate are desirable. In addition, functional materials obtained by providing these organic polymers with a well known additive such as, for example, antistatic, ultraviolet absorber, infrared absorber, plasticizer, lubricant, colorant, antioxidant and/or flame retardant etc. are also available. Moreover, the transparent substrate may be a mixture or a copolymer which is made from a single material or a plurality of materials selected from the organic polymers noted above. The transparent substrate may have not only a single layer but also a multilayer stacking structure.

Among them, a triacetyl cellulose film is preferred to be used when the antireflection film of the present invention is applied on an LCD because triacetyl cellulose has significantly small birefringence and good transparency. Triacetyl cellulose has a refractive index of around 1.50, which is smaller than those of other materials for the transparent substrate. For example, a polyethylene terephthalate film, which is widely used as the transparent substrate, has a refractive index of about 1.60.

In general, the antireflection film which uses a triacetyl cellulose film as the transparent substrate is inclined to generate interference unevenness caused by a difference in the refractive index between the transparent substrate and the hard coat layer because the refractive index of the transparent substrate is smaller than that of the hard coat layer. The antireflection film of the present invention, however, keeps refractive index of the hard coat layer so small that a triacetyl cellulose film is preferably used as the transparent substrate.

The hard coat layer of the antireflection film of the present invention can be formed by coating on the transparent substrate a coating liquid for forming a hard coat layer which contains conductive material (conductive polymer) by a wet coating method.

At this time, polyacetylene, polyaniline, polythiophene, polypyrrole, polyphenylene sulfide, poly(1,6-heptadiyne), polybiphenylene, polyparaphenylene, polyparaphenylene sulfide, polyphenylacetylene, poly(2,5-thienylene) or a derivative compound of these, or a mixture of any combination selected among these can be used as the conductive polymer which is contained in the coating liquid for forming a hard coat layer. A conductive organic material of a heat drying type or an ionizing radiation curable type, which cures by exposure to ionizing radiation such as ultraviolet, can be used as the conductive polymer. Especially, polythiophenes and their derivatives are preferably used as the conductive polymer.

In addition, the coating liquid for forming a hard coat layer may contain an ionizing radiation curable acrylic material. A polyfunctional acrylate such as acrylic (or methacrylic) ester of polyol, or polyfunctional urethane acrylate synthesized from diisocyanate, polyol and hydroxy ester of acrylic (or methacrylic) acid etc. can be used as the acrylic material. Besides these, a polyether resin, a polyester resin, an epoxy resin, an alkyd resin, a spiroacetal resin, polybutadiene resin and polythiol-polyen resin, etc. can be used as the ionizing radiation curable material. These acrylic materials cure by exposure to ionizing radiation such as an electron beam or ultraviolet light so that a high level of hard coat properties are obtained forming a three dimensional web-net structure. In addition, in the case where the coating liquid for forming a hard coat layer contains an ionizing radiation curable acrylic material, it is preferable that the conductive polymer is also a material which cures by ionizing radiation.

In addition, the coating liquid for forming a hard coat layer may contain a photopolymerization initiator. A photopolymerization initiator is added to the coating liquid for forming a hard coat layer in the case where a coated layer is exposed to ionizing radiation to cure after the coating liquid for forming a hard coat layer is coated to arrange the coated layer on the transparent substrate by a wet coating method. Acetophenones, benzoins, benzophenones, phosphine oxides, ketals, anthraquinones and thioxanthones are examples of the photopolymerization initiator. Moreover, n-butylamine, triethylamine and poly-n-butylphosphine etc. can be used as a photosensitizer.

In addition, the coating liquid for forming a hard coat layer may contain metal oxide particles. It is preferable that particles of a conductive metal oxide compound which mainly contain one or more kinds of oxide(s) selected from titanium oxide, zirconium oxide, antimony including tin oxide, phosphor including tin oxide, aluminum oxide, cerium oxide, zinc oxide, aluminum including zinc oxide, tin oxide, antimony including zinc oxide and indium including zinc oxide are used as the metal oxide particles. An antireflection film which shows no decrease in antistatic properties even after a light resistivity test can be obtained if the coating liquid for forming a hard coat layer which contains metal oxide particles is used.

In addition, in the case where the conductive polymer and the metal oxide particles are used to form the hard coat layer, it is preferable that the metal oxide particles are contained at a ratio in the range of 20-1000 parts by weight relative to 100 parts by weight of the conductive polymer. If the metal oxide particles are contained at a ratio less than 20 parts by weight relative to 100 parts by weight of the conductive polymer, a decrease in antistatic properties may be observed after a light resistivity test. If the metal oxide particles are contained at a ratio more than 1000 parts by weight relative to 100 parts by weight of the conductive polymer, a decrease in light transmission and/or generation of interference unevenness may be observed after a light resistivity test.

In addition, a solvent is added to the coating liquid for forming a hard coat layer. The solvent serves to improve coating suitability of the coating liquid. The solvent is appropriately selected from aromatic hydrocarbons such as toluene, xylene, cyclohexane and cyclohexyl benzene etc., aliphatic hydrocarbons such as n-hexane etc., ethers such as dibutyl ether, dimethoxy methane, dimethoxy ethane, diethoxy ethane, propylene oxide, dioxane, dioxolane, trioxane, tetrahydrofuran, anisole and phenetole etc., ketones such as methyl isobutyl ketone, methyl butyl ketone, acetone, methyl ethyl ketone, diethyl ketone, dipropyl ketone, diisobutyl ketone, cyclopentanone, cyclohexanone and methyl cyclohexanone etc., esters such as ethyl formate, propyl formate, n-pentyl formate, methyl acetate, ethyl acetate, methyl propionate, ethyl propionate, n-pentyl acetate and γ-butyrolactone etc., cellosolves such as methyl cellosolve, ethyl cellosolve, butyl cellosolve and cellosolve acetate etc., alcohols such as methanol, ethanol, n-propyl alcohol, isopropyl alcohol and ethylene glycol etc., and water etc. considering the coating suitability etc.

In order to avoid generating coating defects such as repellency and unevenness etc. on the coated layer, a surface conditioner may be added to the coating liquid for forming a hard coat layer. The surface conditioner may also be called a leveling agent, antifoam, interfacial tension conditioner or surface tension conditioner etc. Regardless of its name, however, it decreases the surface tension of the coated layer (hard coat layer).

In addition, the coating liquid for forming a hard coat layer may contain other additives than the surface conditioner mentioned above. An antistat, an ultraviolet absorber, an infrared absorber, an adhesion improver and a curing agent are examples of the other additives.

The hard coat layer can be formed by coating such a coating liquid for forming a hard coat layer as is prepared from the materials described above on a transparent substrate by a wet coating method to make the coated layer. In the case where the ionizing radiation curable material is used, the hard coat layer is formed by exposing ionizing radiation such as ultraviolet light or an electron beam after drying the coated layer if necessary. In contrast, in the case where the heat drying material is used as the binder matrix forming material, the hard coat layer is formed by drying and heating etc.

At this point, a coating method in which a roll coater, a reverse roll coater, a gravure coater, a micro gravure coater, a knife coater, a bar coater, a wire bar coater, a die coater or a dip coater is used can be employed as the wet coating method.

The antireflection film of the present invention is preferred to have a hard coat layer with a pencil hardness higher than (or equal to) H so as to ensure sufficient abrasion resistance.

Next, a forming method of a low refractive index single layer by a wet coating method in which a coating liquid for forming a low refractive index layer containing a binder matrix forming material and low refractive index particles is coated on a surface of the hard coat layer is described. At this time, a thickness (d) of the low refractive index single layer is designed in such a way that an optical thickness (nd), which is obtained by multiplying the thickness (d) by a refractive index (n) of the low refractive index layer, corresponds to one fourth the wavelength of the visible light. A binder matrix combined with low refractive index particles dispersed therein can be used as the material of the low refractive index layer.

Particles made of low refractive index materials such as LiF, MgF, 3NaF.AlF or AlF, each of which has a refractive index of 1.4, or Na₃AlF₆ (cryolite, refractive index: 1.33) etc. can be used as the low refractive particles. In addition, particles which include pores inside can also be used preferably. Such particles have a significantly low refractive index since the pores can be considered to have a refractive index of air (namely, almost equal to 1.0). Practically, porous silica particles or low refractive index silica particles with pores inside can be used as the particles.

The low refractive index particles used in the low refractive index layer of the present invention are preferred to have a size (diameter) in the range of 1-100 nm. If the particles have a diameter more than 100 nm, light is severely reflected by Rayleigh scattering and the low refractive index layer is inclined to be whitely clouded resulting in degradation in transparency of the antireflection film. In contrast, if the particles have a diameter less than 1 nm, there is a problem of an uneven distribution of the particles in the low refractive index layer caused by an agglutination of the particles.

A silicon alkoxide hydrolysate can be used as the binder matrix forming material. More specifically, a hydrolysate of a silicon alkoxide which has a general expression of Formula 1 below can be used.

RₓSi(OR)₄₋ₓ <Formula 1>

where R refers to an alkyl group and x is an integer which satisfies

0≦x≦3.

For example, tetramethoxysilane, tetraethoxysilane, tetraisopropoxysilane, tetra-n-propoxysilane, tetra-n-butoxysilane, tetra-sec-butoxysilane, tetra-tert-butoxy silane, tetrapentaethoxysilane, tetrapenta-iso-propoxysilane, tetrapenta-n-propoxysilane, tetrapenta-n-butoxysilane, tetrapenta-sec-butoxysilane, tetrapenta-tert-butoxysilane, methyltrimethoxysilane, methyltriethoxysilane, methyltripropoxysilane, methyltributoxysilane, dimethyldimethoxysilane, dimethyldiethoxysilane, dimethylethoxysilane, dimethylpropoxysilane, dimethylbutoxysilane, methyldimethoxysilane, methyldiethoxysilane and hexyltrimethoxysilane etc. can be used as the silicon alkoxide which is expressed as the Formula 1. The hydrolysate of a silicon alkoxide which is expressed as the Formula 1 can be obtained by, for example, a hydrolysis reaction with hydrochloric acid.

Furthermore, a blend material which is obtained by adding a hydrolysate of a silicon alkoxide expressed as Formula 2 noted below to a hydrolysate of a silicon alkoxide expressed as Formula 1 mentioned above can be used as the binder matrix forming material of the low refractive index layer. Then, it is possible to provide the low refractive index layer surface with antifouling properties and to make the refractive index of the low refractive index layer even lower.

R′_{z}Si(OR)_{4-z} <Formula 2>

where R′ refers to a non-reactive functional group having an alkyl group, a fluoroalkyl group or a fluoroalkylene group and z is an integer which satisfies

0≦z≦3.

Octadecyltrimethylsilane and 1H,1H,2H,2H-perfluorooctyltrimethoxysilane etc. are examples of the hydrolysate of a silicon alkoxide expressed as Formula 2.

In addition, an ionizing radiation curable material can also be used as the binder matrix forming material. A polyfunctional acrylate such as polyfunctional urethane acrylate etc. can be used as the ionizing radiation curable material. Besides these, a polyether resin, a polyester resin, an epoxy resin, an alkyd resin, a spiroacetal resin, a polybutadiene resin and a polythiol polyen resin which have an acrylic functional group etc. can also be used as the binder matrix forming material.

In addition, a solvent and various additives may be added to the coating liquid for forming a low refractive index layer, if necessary. The solvent is appropriately selected from aromatic hydrocarbons such as toluene, xylene, cyclohexane and cyclohexyl benzene etc., aliphatic hydrocarbons such as n-hexane etc., ethers such as dibutyl ether, dimethoxy methane, dimethoxy ethane, diethoxy ethane, propylene oxide, dioxane, dioxolane, trioxane, tetrahydrofuran, anisole and phenetole etc., ketones such as methyl isobutyl ketone, methyl butyl ketone, acetone, methyl ethyl ketone, diethyl ketone, dipropyl ketone, diisobutyl ketone, cyclopentanone, cyclohexanone and methyl cyclohexanone etc., esters such as ethyl formate, propyl formate, n-pentyl formate, methyl acetate, ethyl acetate, methyl propionate, ethyl propionate, n-pentyl acetate and y-butyrolactone etc., cellosolves such as methyl cellosolve, cellosolve, butyl cellosolve and cellosolve acetate etc., alcohols such as methanol, ethanol and isopropyl alcohol etc., and water etc. considering the coating suitability etc. The coating liquid may also include additives such as a surface conditioner, leveling agent, refractive index conditioner, adhesiveness improver and/or photosensitizer etc.

In addition, in the case where an ionizing radiation curable material is used as the binder matrix forming material and the low refractive index layer is formed by irradiating ultraviolet light, a photopolymerization initiator is added to the coating liquid. Acetophenones, benzoins, benzophenones, phosphine oxides, ketals, anthraquinones and thioxanthones are examples of the photopolymerization initiator.

The low refractive index layer can be formed by preparing the coating liquid for forming a low refractive index layer which includes the materials described above and coating the coating liquid on the transparent substrate by a wet coating method to form a coated layer. In the case where an ionizing radiation curable material is used as the binder matrix forming material, the low refractive index layer is formed by exposing the coated layer to ionizing radiation such as ultraviolet light or an electron beam after drying the coated layer if necessary. In the case where a metal alkoxide is used as the binder matrix forming material, the low refractive index layer is formed by drying or heating etc.

At this time, a coating method in which a roll coater, a reverse roll coater, a gravure coater, a micro gravure coater, a knife coater, a bar coater, a wire bar coater, a die coater or a dip coater is used can be employed as the wet coating method.

The antireflection film of the present invention is manufactured as described above.

### EXAMPLES

Examples of the present invention will be described below. The present invention is not limited only to these examples.

The coating liquids for forming a hard coat layer were prepared according to the preparation examples 1-7 below. In addition, the coating liquids for forming a low refractive index layer were formed according to the preparation example 8.

### Preparation Example 1

### (Coating Liquid for Forming a Hard Coat Layer 1)

A coating liquid for forming a hard coat layer 1 was prepared by dissolving 33 parts by weight of Baytron P CH 8000 (solid content: 3%, made by H. C. Starck Ltd.) which contains a conductive polymer, 1 part by weight of tin oxide which contains antimony, 25 parts by weight of dipentaerythritol triacrylate, 25 parts by weight of pentaerythritol tetraacrylate, 50 parts by weight of urethane acrylate, and 5 parts by weight of Irgacure 184 (a photopolymerization initiator, made by Ciba Specialty Chemicals Inc.) in methyl ethyl ketone.

### Preparation Example 2

### (Coating Liquid for Forming a Hard Coat Layer 2)

A coating liquid for forming a hard coat layer 2 was prepared by dissolving 33 parts by weight of Baytron P CH 8000 (solid content: 3%, made by H. C. Starck Ltd.) which contains a conductive polymer, 5 parts by weight of tin oxide which contains antimony, 25 parts by weight of dipentaerythritol triacrylate, 25 parts by weight of pentaerythritol tetraacrylate, 50 parts by weight of urethane acrylate, and 5 parts by weight of Irgacure 184 (a photopolymerization initiator, made by Ciba Specialty Chemicals Inc.) in methyl ethyl ketone.

### Preparation Example 3

### (Coating Liquid for Forming a Hard Coat Layer 3)

A coating liquid for forming a hard coat layer 3 was prepared by dissolving 33 parts by weight of Baytron P CH 8000 (solid content: 3%, made by H. C. Starck Ltd.) which contains a conductive polymer, 25 parts by weight of dipentaerythritol triacrylate, 25 parts by weight of pentaerythritol tetraacrylate, 50 parts by weight of urethane acrylate, and 5 parts by weight of Irgacure 184 (a photopolymerization initiator, made by Ciba Specialty Chemicals Inc.) in methyl ethyl ketone.

### Preparation Example 4

### (Coating Liquid for Forming a Hard Coat Layer 4)

A coating liquid for forming a hard coat layer 4 was prepared by dissolving 33 parts by weight of Baytron P CH 8000 (solid content: 3%, made by H. C. Starck Ltd.) which contains a conductive polymer, 0.1 parts by weight of tin oxide which contains antimony, 25 parts by weight of dipentaerythritol triacrylate, 25 parts by weight of pentaerythritol tetraacrylate, 50 parts by weight of urethane acrylate, and 5 parts by weight of Irgacure 184 (a photopolymerization initiator, made by Ciba Specialty Chemicals Inc.) in methyl ethyl ketone.

### Preparation Example 5

### (Coating Liquid for Forming a Hard Coat Layer 5)

A coating liquid for forming a hard coat layer 5 was prepared by dissolving 1 part by weight of tin oxide which contains antimony, 25 parts by weight of dipentaerythritol triacrylate, 25 parts by weight of pentaerythritol tetraacrylate, 50 parts by weight of urethane acrylate, and 5 parts by weight of Irgacure 184 (a photopolymerization initiator, made by Ciba Specialty Chemicals Inc.) in methyl ethyl ketone.

### Preparation Example 6

### (Coating Liquid for Forming a Hard Coat Layer 6)

A coating liquid for forming a hard coat layer 6 was prepared by dissolving 33 parts by weight of Baytron P CH 8000 (solid content: 3%, made by H. C. Starck Ltd.) which contains a conductive polymer, 20 parts by weight of tin oxide which contains antimony, 25 parts by weight of dipentaerythritol triacrylate, 25 parts by weight of pentaerythritol tetraacrylate, 50 parts by weight of urethane acrylate, and 5 parts by weight of Irgacure 184 (a photopolymerization initiator, made by Ciba Specialty Chemicals Inc.) in methyl ethyl ketone.

### Preparation Example 7

### (Coating Liquid for Forming a Hard Coat Layer 7)

A coating liquid for forming a hard coat layer 7 was prepared by dissolving 20 parts by weight of tin oxide which contains antimony, 25 parts by weight of dipentaerythritol triacrylate, 25 parts by weight of pentaerythritol tetraacrylate, 50 parts by weight of urethane acrylate, and 5 parts by weight of Irgacure 184 (a photopolymerization initiator, made by Ciba Specialty Chemicals Inc.) in methyl ethyl ketone.

### Preparation Example 8

### (Coating Liquid for Forming a Low Refractive Index Layer)

A coating liquid for forming a low refractive index layer was prepared by diluting 14.94 parts by weight of a dispersion liquid of porous silica particles (average particle diameter: 50 nm, solid content: 20%, solvent: methyl isobutyl ketone.), 1.99 parts by weight of EO-modified dipentaerythritol hexaacrylate (trade name: DPEA-12, made by Nippon Kayaku Co., Ltd.), 0.07 parts by weight of a photopolymerization initiator (trade name: Irgacure 184, made by Ciba Specialty Chemicals Inc.), and 0.20 parts by weight of an alkyl polyether modified silicone oil (trade name: TSF446, made by GE Toshiba Silicone Co., Ltd.) with a solvent, namely, 82 parts by weight of methyl isobutyl ketone.

### Example 1

### (Formation of the Hard Coat Layer)

A transparent hard coat layer having a thickness of 5 μm (under a dry condition) was formed by coating the coating liquid for forming a hard coat layer 1 on a surface of a triacetyl cellulose film (thickness: 80 μm, a product made by Fujifilm Corp.) followed by drying in an oven at 80° C. for 60 seconds and exposing to 300 mJ/m² of ultraviolet light using an UV irradiating device (light source: H bulb, made by Fusion UV Systems, Inc.).

### (Formation of the Low Refractive Index Layer)

The coating liquid for forming a low refractive index layer was coated on the hard coat layer described above in a way that the resultant thickness of the low refractive index layer (after drying) became 100 nm. The layer was cured by exposing to 192 mJ/m² of ultraviolet light using an UV irradiating device (light source: H bulb, made by Fusion UV Systems, Inc.) to form the low refractive index layer so that the antireflection film was fabricated.

### Example 2

The antireflection film was obtained in the same way as in Example 1. However, whereas the coating liquid for forming a hard coat layer 1 was used in Example 1 the coating liquid for forming a hard coat layer 2 was used in Example 2.

### Example 3

The antireflection film was obtained in the same way as in Example 1. However, whereas the coating liquid for forming a hard coat layer 1 was used in Example 1, the coating liquid for forming a hard coat layer 3 was used in Example 3.

### Example 4

The antireflection film was obtained in the same way as in Example 1. However, whereas the coating liquid for forming a hard coat layer 1 was used in Example 1, the coating liquid for forming a hard coat layer 4 was used in Example 4.

### Comparative Example 1

The antireflection film was obtained in the same way as in Example 1. However, whereas the coating liquid for forming a hard coat layer 1 was used in Example 1, the coating liquid for forming a hard coat layer 5 was used in Comparative example 1.

### Comparative Example 2

The antireflection film was obtained in the same way as in Example 1. However, whereas the coating liquid for forming a hard coat layer 1 was used in Example 1, the coating liquid for forming a hard coat layer 6 was used in Comparative example 2.

### Comparative Example 3

The antireflection film was obtained in the same way as in Example 1. However, whereas the coating liquid for forming a hard coat layer 1 was used in Example 1, the coating liquid for forming a hard coat layer 7 was used in Comparative example 3.

The antireflection films obtained in the Examples 1-4 and the Comparative examples 1-3 were evaluated in the following way.

### (Spectral Reflectance and Average Luminous Reflectance)

Spectral reflectance of the low refractive index layer surfaces of the antireflection films obtained in the Examples and Comparative examples was measured by an auto photospectrometer U-4000 made by Hitachi, Ltd. The incidence angle was 5 degrees, and an antireflection treatment had been performed by coating a matte black paint on the opposite side of the transparent substrate (triacetyl cellulose film) from the low refractive index layer. In addition, the average luminous reflectance was obtained from the resultant spectral reflectance curves.

### (Light Transmittance and Haze)

Light transmittance (total luminous transmittances) and hazes of the antireflection films obtained in the Examples and Comparative examples was measured according to JIS (Japanese Industrial Standard) B 7105 (1981) using a haze meter NDH-2000 made by Nippon Denshoku Industries Co., Ltd.

### (Pencil Hardness)

Pencil hardness of the antireflection films obtained in the Examples and Comparative examples was measured by a testing method conforming to JIS K 5600-5-4 (1999) with a 500 grams load.

### (Surface Resistance)

Surface resistance of the low refractive index layer's surfaces of the antireflection films obtained in the Examples and Comparative examples was measured conforming to JIS K 6911. In addition, the antireflection films were kept in a light resistance testing instrument which employs a carbon arc ultraviolet lamp conforming to JIS B 7751 (1990) for 500 hours, and surface resistance of the low refractive index layer's surfaces after the light resistance test was measured according to JIS K 6911.

### (Adhesiveness)

After the low refractive index layer's surface of the antireflection film obtained in the Examples and Comparative examples was cut in 10×10=100 grids of 1 mm×1 mm squares, a piece of adhesion tape (24 mm wide Cellotape (registered trademark) for industrial use, made by Nichiban Co., Ltd.) was attached to the surface of the low refractive index layer, and a peel off test was performed (the piece of adhesion tape was peeled off from the antireflection film). The rate of squares on which the low refractive index layers were not peeled off with the adhesion tape was evaluated. If all of the 100 squares of the low refractive index layer were left, the result was evaluated as 100/100.

### (Interference Fringe)

After the opposite surface of the triacetyl cellulose film of the transparent substrate from the low refractive index layer was formed was coated with a matte black paint, an antireflection film obtained in the Examples and Comparative examples was observed under fluorescent light and checked whether an interference fringe pattern was seen on the surface of the low refractive index layer. The antireflection film was evaluated as a cross if an interference fringe was seen, while evaluated as a circle if an interference fringe was not seen.

### (Abrasion Resistance)

A surface of the low refractive index layer of the antireflection film obtained in the Examples and Comparative examples was rubbed reciprocating 10 laps with steel-wool (#0000) with a load of 250 gram-weight and checked whether any scratch marks were made. The antireflection film was evaluated as a circle if no scratch marks were found, while evaluated as a cross if any scratch marks were found.

The evaluation results are shown in Table 1 and 2.

TABLE 1

| | | | Surface | |
|---|---|---|---|---|
| | | | resistance | |
| | | | after the | Light |
| | Average | Surface | light | transmittance |
| | luminous | resistance | resistance | (total luminous |
| | reflectance | [Ω/□] | test [Ω/□] | transmittance) |
| Example 1 | 1.0% | 5 × 10⁶ | 7 × 10⁶ | 93.0% |
| Example 2 | 1.0% | 5 × 10⁶ | 6 × 10⁶ | 92.7% |
| Example 3 | 1.0% | 5 × 10⁶ | 4 × 10¹³ | 93.2% |
| Example 4 | 1.0% | 5 × 10⁶ | 5 × 10¹¹ | 93.1% |
| Comparative | 1.0% | 5 × 10¹¹ | 5 × 10¹¹ | 93.1% |
| example 1 | | | | |
| Comparative | 1.7% | 5 × 10⁶ | 5 × 10⁶ | 90.0% |
| example 2 | | | | |
| Comparative | 1.7% | 5 × 10⁹ | 5 × 10⁹ | 90.0% |
| example 3 | | | | |

TABLE 2

| | Haze | Pencil | Adhesive- | Interference | Abrasion |
|---|---|---|---|---|---|
| | value | hardness | ness | fringe | resistance |
| Example 1 | 0.2% | 3H-5/5 | 100/100 | ∘ | ∘ |
| Example 2 | 0.2% | 3H-5/5 | 100/100 | ∘ | ∘ |
| Example 3 | 0.2% | 3H-5/5 | 100/100 | ∘ | ∘ |
| Example 4 | 0.2% | 3H-5/5 | 100/100 | ∘ | ∘ |
| Comparative | 0.2% | 3H-5/5 | 100/100 | ∘ | x |
| example 1 | | | | | |
| Comparative | 0.5% | 3H-0/5 | 50/100 | x | x |
| example 2 | | | | | |
| Comparative | 0.5% | 3H-0/5 | 50/100 | x | x |
| example 3 | | | | | |

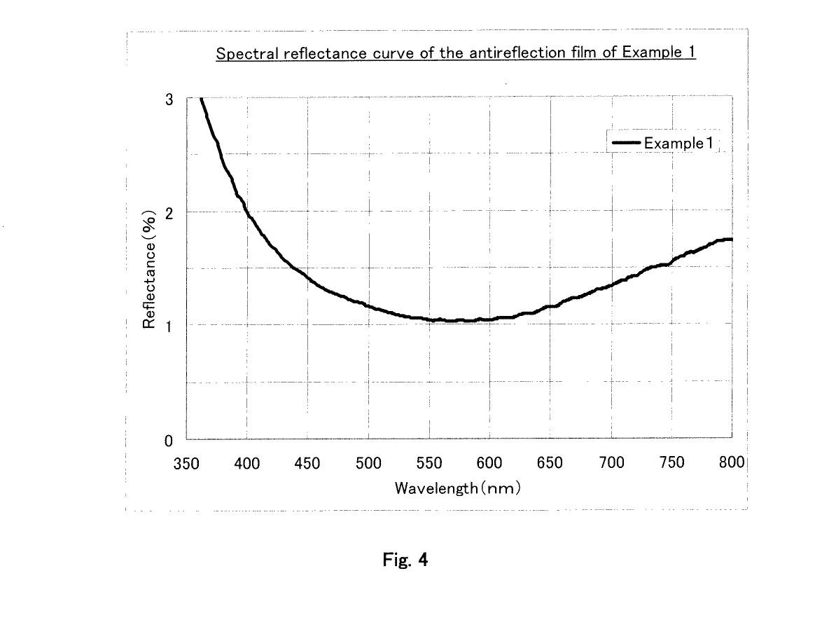

FIG. 4 shows a spectral reflectance curve of the antireflection film obtained in Example 1.

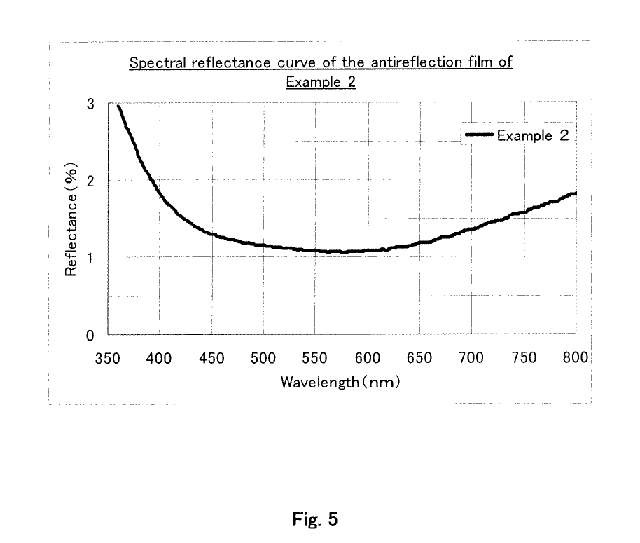

FIG. 5 shows a spectral reflectance curve of the antireflection film obtained in Example 2.

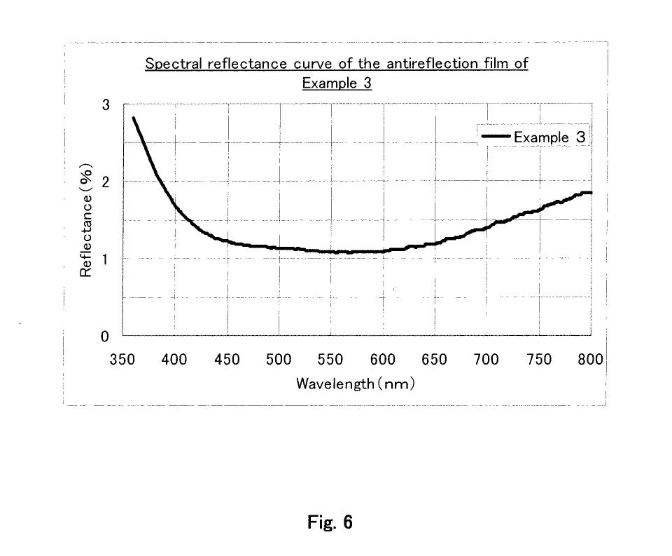

FIG. 6 shows a spectral reflectance curve of the antireflection film obtained in Example 3.

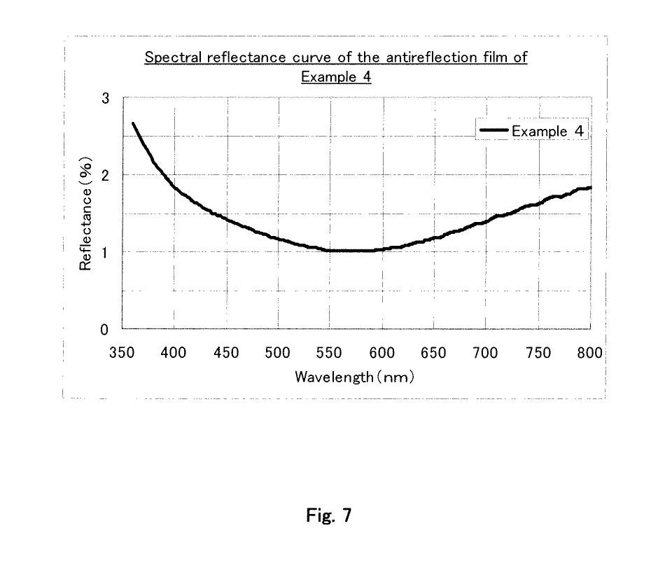

FIG. 7 shows a spectral reflectance curve of the antireflection film obtained in Example 4.

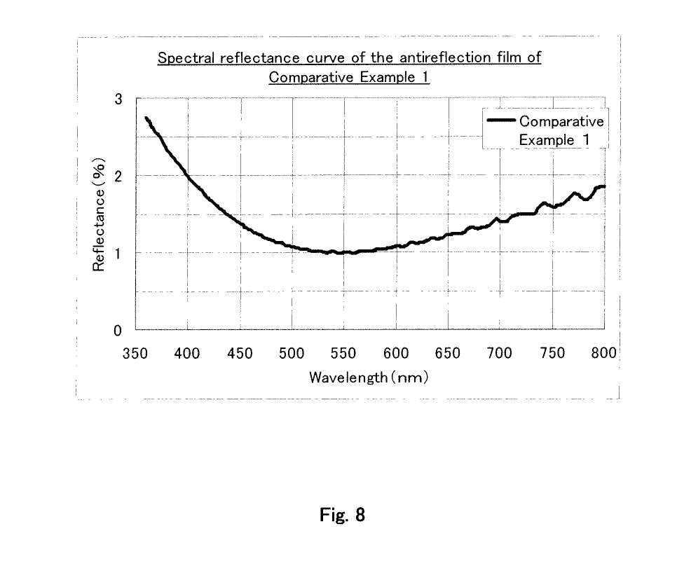

FIG. 8 shows a spectral reflectance curve of the antireflection film obtained in Comparative example 1.

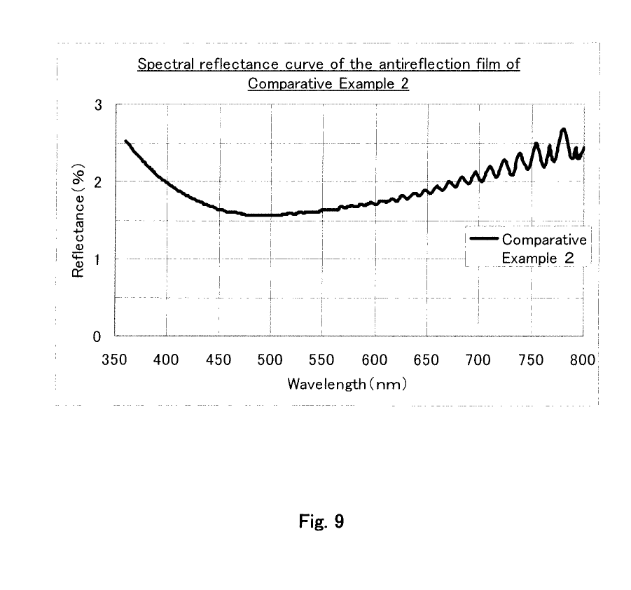

FIG. 9 shows a spectral reflectance curve of the antireflection film obtained in Comparative example 2.

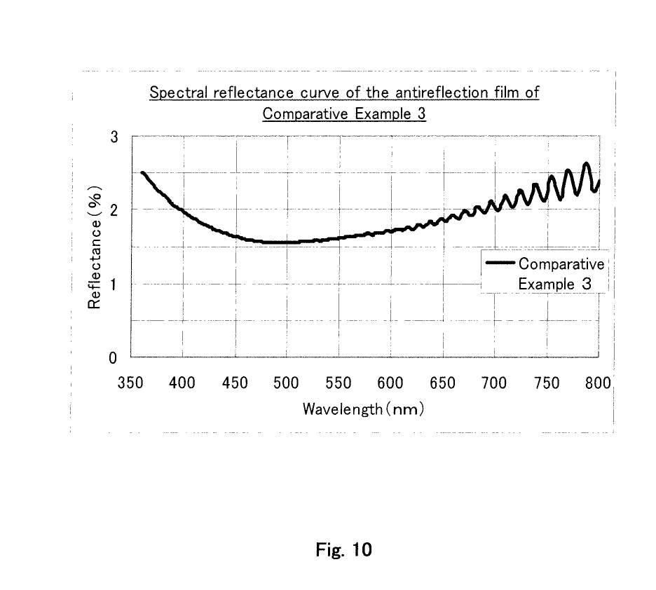

FIG. 10 shows a spectral reflectance curve of the antireflection film obtained in Comparative example 3.

As is apparent in Tables 1 and 2, the antireflection films of the Examples 1-4 had low spectral reflectance in a wide visible range so that luminous reflectance was also low. As a result, antireflection films having sufficient antireflection properties were obtained. In addition, the antireflection films had sufficient antistatic properties. Moreover, it was observed visually that the antireflection films had almost no interference fringe pattern. Furthermore, the antireflection films had low haze values, high light transmittance (which means a high level of transparency), excellent abrasion resistance, pencil hardness, antifouling properties and adhesiveness.

What is claimed is:

1. An antireflection film comprising:
a transparent substrate;
a hard coat layer; and
a low refractive index layer, the low refractive index layer having an average luminous reflectance in the range of 0.5-1.5% and a surface resistance less than or equal to 1×10¹⁰ [Ω/cm²].

2. The antireflection film according to claim 1, wherein said hard coat layer includes conductive metal oxide particles, and a surface resistance of said low refractive index layer after said antireflection film is kept for 500 hours in a light resistance testing instrument which employs an ultraviolet carbon arc lamp is less than or equal to 1×10¹⁰ [Ω/cm²].

3. The antireflection film according to claim 1, wherein a light transmittance or a total luminous transmittance of said antireflection film is in the range of 92-98%.

4. The antireflection film according to claim 2, wherein a light transmittance or a total luminous transmittance of said antireflection film is in the range of 92-98%.

5. The antireflection film according to claim 1, wherein a haze of said antireflection film is in the range of 0.1-0.5%.

6. The antireflection film according to claim 2, wherein a haze of said antireflection film is in the range of 0.1-0.5%.

7. The antireflection film according to claim 3, wherein a haze of said antireflection film is in the range of 0.1-0.5%.

8. The antireflection film according to claim 4, wherein a haze of said antireflection film is in the range of 0.1-0.5%.

9. The antireflection film according to claim 1, wherein low refractive index particles are included in said low refractive index layer.

10. The antireflection film according to claim 2, wherein low refractive index particles are included in said low refractive index layer.

11. The antireflection film according to claim 3, wherein low refractive index particles are included in said low refractive index layer.

12. The antireflection film according to claim 5, wherein low refractive index particles are included in said low refractive index layer.

13. The antireflection film according to claim 8, wherein low refractive index particles are included in said low refractive index layer.

14. A polarizing plate comprising said antireflection film according to claim 1.

15. A polarizing plate comprising said antireflection film according to claim 2.

16. A polarizing plate comprising said antireflection film according to claim 3.

17. A polarizing plate comprising said antireflection film according to claim 5.

18. A polarizing plate comprising said antireflection film according to claim 13.

19. A display device comprising said antireflection film according to claim 1.

20. A display device comprising said antireflection film according to claim 13.
